(19) United States
(12) Patent Application Publication
(10) Pub. No.: US 2009/0109932 A1
(43) Pub. Date: Apr. 30, 2009

(54) Fast urgent services support over 802.16 air interface

(75) Inventors: Shashikant Maheshwari, Irving, TX (US); Haihong Zheng, Coppell, TX (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 11/976,569

(22) Filed: Oct. 25, 2007

(51) Int. Cl. H04B 7/216

(52) U.S. Cl. 370/335

(57) ABSTRACT

Among the proposals of the present application is a method that includes receiving a bandwidth request with a code division multiple access code from a first network node to a second network node. The method also includes processing the bandwidth request at the second network node. The method further includes receiving a first portion of an urgent service data flow related to the bandwidth request after fewer than four round trips of communication between the first network node and the second network node.

### CROSS REFERENCE TO RELATED APPLICATIONS

This application is not related to and does not claim the priority of any previously filed application.

### BACKGROUND OF THE INVENTION

1. Field of the Invention

A new task group, Institute of Electrical and Electronics Engineers (IEEE) 802.16m, has been established within the IEEE 802.16 working group to define an air interface to meet International Mobile Telecommunications (IMT) requirements. Among other general requirements, support of government mandates and public safety first responders, military, emergency services such as call-prioritization, preemption, push-to-talk may be required.

2. Description of the Related Art

Urgent services such as emergency services, push-to-talk, gaming (such as real-time gaming), public safety first responders require fast call set up and/or fast channel set up time. These are just some examples of urgent services, as any other service that requires fast call set up time and/or fast channel set up time may also be considered urgent services. However, with the current 802.16d/e scheme, the call set up time requires at least four round trips (50-100 ms total) over the air interface.

FIG. 1 illustrates the current 802.16d/e scheme. As shown in FIG. 1, in a first step (1), a Mobile Station (MS) selects a Code Division Multiple Access (CDMA) ranging code from the code subset allocated to bandwidth requests. Upon detection of such bandwidth request ranging code, in step (2), the Base Station (BS) provides an uplink allocation (using a CDMA_Allocation-IE) for the MS to send a bandwidth request.

Subsequently, in step (3), the MS uses the allocated bandwidth to send a bandwidth request Media Access Control (MAC) Packet Data Unit (PDU) to request bandwidth to send a Dynamic Service Addition (DSA) Request (DSA-REQ). Consequently, in step (4), the BS provides an uplink allocation to the MS. Then, in step (5), the MS uses the uplink allocation to send a DSA-REQ to set up a new service flow to carry the urgent service data flow.

After that, in step (6), the BS replies with a DSA Response (DSA-RSP), and in step (7) the MS then confirms with a DSA Acknowledgment (DSA-ACK). After the service flow is established, in step (8), the BS provides uplink allocation to the MS based on the service flow parameter. Finally, in step (9), the urgent service data flow goes through.

The call set up time involves delay produced by multiple round trips and consequently may not be fully suitable for urgent services.

### SUMMARY OF THE INVENTION

A method according to an embodiment of the present invention can include sending a bandwidth request to a base station, wherein the bandwidth request comprises a code division multiple access code. The method can also include receiving an uplink mapping message from the base station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included. The method can further include beginning an urgent service data flow to the base station, in response to the uplink mapping message.

Another method according to an embodiment of the present invention can include receiving a bandwidth request from a mobile station, wherein the bandwidth request comprises a code division multiple access code. The method can also include sending an uplink mapping message to the mobile station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included. The method can further include receiving an urgent service data flow from the mobile station, in response to the uplink mapping message.

Another embodiment of the present invention can be an apparatus including sending means for sending a bandwidth request to a base station, wherein the bandwidth request comprises a code division multiple access code. The apparatus can also include receiving means for receiving an uplink mapping message from the base station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included. The apparatus can further include initiation means for beginning an urgent service data flow to the base station, in response to the uplink mapping message.

Another apparatus that can be an embodiment of the present invention can include first receiving means for receiving a bandwidth request from a mobile station, wherein the bandwidth request comprises a code division multiple access code. The apparatus can also include sending means for sending an uplink mapping message to the mobile station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included. The apparatus can further include second receiving means for receiving an urgent service data flow from the mobile station, in response to the uplink mapping message.

A further embodiment of the present invention can be a system. The system can include first sending means for sending a bandwidth request, wherein the bandwidth request comprises a code division multiple access code. The system can also include first receiving means for receiving the bandwidth request. The system can further include processing means for processing the request. The system can additionally include second sending means for sending an uplink mapping message in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included. The system can also include receiving means for receiving the uplink mapping message. The system can further include initiation means for beginning an urgent service data flow, in response to the uplink mapping message.

### BRIEF DESCRIPTION OF THE DRAWINGS

For proper understanding of the invention, reference should be made to the accompanying drawings, wherein:

FIG. 1 illustrates a conventional setup procedure for an urgent service data flow;

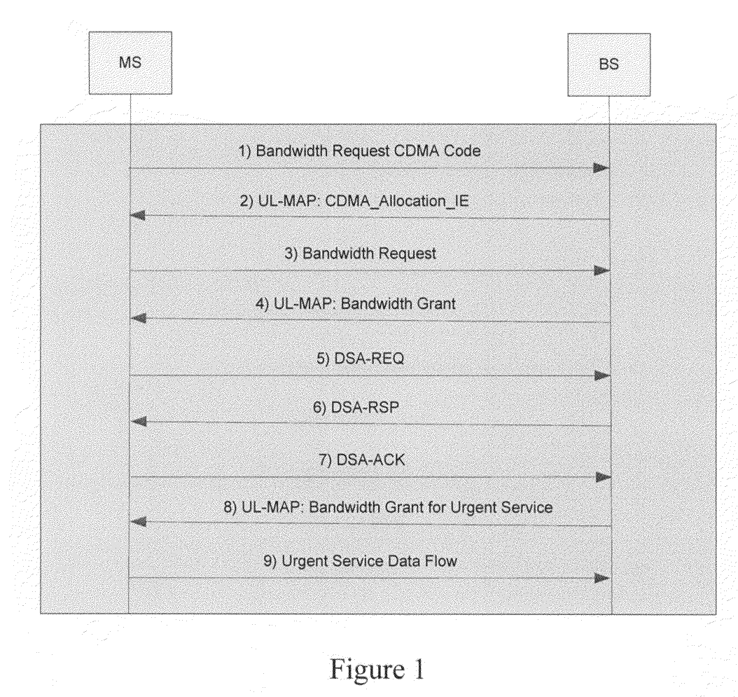

FIG. 2 illustrates the use of a dedicated bandwidth request ranging code for urgent services for a specific mobile station (MS);

FIG. 3 illustrates the use of a dedicated bandwidth request ranging code for each urgent service;

FIG. 4 illustrates the use of a bandwidth request indicating an urgent service type;

FIG. 5 illustrates the use of a dedicated bandwidth request ranging code for each urgent service;

FIG. 6 illustrates the assignment of a ranging code during a DSA procedure;

FIG. 7 illustrates the use of a dedicated bandwidth request ranging code for urgent services for a specific mobile station (MS) and an optional piggybacked bandwidth request;

FIG. 8 illustrates a system according to an embodiment of the present invention;

FIG. 9 illustrates a method according to an embodiment of the present invention; and

FIG. 10 illustrates a method according to an embodiment of the present invention.

### DETAILED DESCRIPTION OF THE PREFERRED EMBODIMENT(S)

Urgent services such as emergency services, push-to-talk, gaming, public safety first responders, and the like may require fast call and service flow set up time. These are just examples of urgent services, with other services that require fast call set up and/or service flow set up time being considered urgent services as well. The present application describes multiple schemes to reduce call/session setup time or channel setup time for urgent services.

In general, certain embodiments of the present invention can determine whether a requested service is “urgent,” and, when an “urgent” service is confirmed, map the urgent connection request to a pre-defined service flow profile. One way to determine whether a requested service is “urgent” is to check for the use of a dedicated ranging code assigned for urgent services. Such a process can eliminate the usual service flow establishment procedure.

Accordingly, in order to reduce call and service flow set up time for urgent services, certain embodiments of the present invention pre-define service flow profile and procedure for each type of urgent service so that the service flow establishment procedure can be removed. The MS and BS can directly map the connection carrying the urgent service to the pre-defined service flow profile.

In order for the BS to determine that the requested service is for an urgent service type, the following can be used: a dedicated ranging code per MS, a set of ranging codes among all the MSs, or a special bandwidth request message with urgent service indication. The urgent service data flow could be carried over basic/primary/second Connection Identifier (CID) or a transport CID. If a transport CID is used, the transport CID and the associated service flow ID could be assigned in the following manner: they could be assigned together with the first uplink (UL) allocation for the urgent service or they could be assigned during network entry procedure such as ranging or registration. In this case, the BS can reserve and assign a CID and service flow ID to the MS when the service profile indicates that the MS supports the relevant urgent services.

An alternative embodiment is also to let the MS use a dedicated ranging code, either allocated to one MS or shared among all the MSs for a specific service, to request for bandwidth. The BS allocates sufficient bandwidth to the MS, which—in turn—is used by the MS to send a DSA-REQ to establish the service flow. Thereafter, the non-CDMA code based bandwidth request procedure can be removed to reduce call and service flow setup time for urgent services. The BS can then forward the data to the corresponding network element after receiving an urgent service connection.

Furthermore, urgent services such as push-to-talk require a fast channel setup after a silence period during an urgent service session. In order to reduce the delay, a dedicated ranging code for the urgent service can be allocated to the MS. Such a dedicated ranging code could be allocated during the Dynamic Service Addition (DSA) procedure, or during a network entry procedure (e.g., ranging, registration procedures). After receiving such a ranging code, the BS can allocate bandwidth for the MS to send urgent service data flow. The amount of bandwidth to allocate could be based on the minimum bit rate defined for the service flow. If the MS still has more data to send after using this allocation, the MS may send piggybacked bandwidth request together with the urgent service data.

Five detailed schemes are discussed below. Different schemes can be applied for different types of urgent service. The five detailed schemes are not necessarily mutually exclusive (Scheme 1, for example, can be viewed as a subset of Scheme 5) and are presented as examples, not as an exhaustive list.

Scheme 1

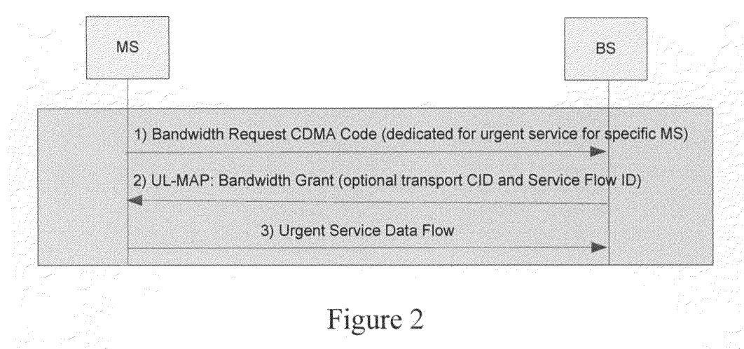

In Scheme 1, each MS is assigned uniquely with one or more dedicated ranging code from the code set just for urgent services. A service flow profile is predefined for each type of urgent service. In this example scheme, only the steps shown in FIG. 2 are taken when an urgent service is set up.

FIG. 2 illustrates the use of a dedicated bandwidth request ranging code for urgent services for a specific mobile station (MS).

As shown in FIG. 2, at step (1), the MS uses the CDMA ranging code uniquely assigned to itself for the urgent service by the BS during the network entry process. At step (2), upon receiving the dedicated ranging code, the BS detects the MS as well as the type of service request and then allocates the bandwidth for the MS to send the urgent service data flow using Uplink Mapping (UL-MAP) based on the predefined service flow parameter. Finally, at step (3), the urgent service data flow is sent using the bandwidth allocated in step (2) with the transport CID (which can be allocated in step (2) or during network entry procedure) or a basic/primary/secondary CID for the MS.

Scheme 2

In scheme 2, one or more dedicated ranging code from the code set is reserved for urgent services. A service flow profile is predefined for each type of urgent service. Different urgent service types can share the same ranging code if they have the same service flow requirement. All the MSs share the same ranging code for the same urgent service type. Upon receiving the dedicated ranging code for urgent service, the BS directly allocates bandwidth for the MS to send the bandwidth request.

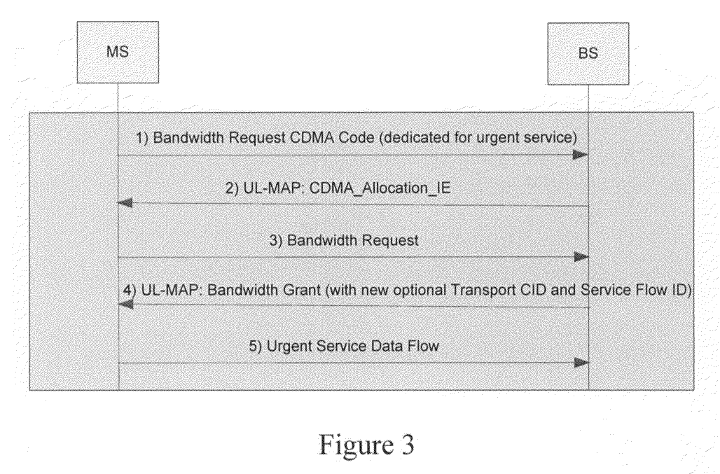

FIG. 3 illustrates the use of a dedicated bandwidth request ranging code for each urgent service. In the example shown in FIG. 3, only the following steps are taken when an urgent service is set up.

As shown in FIG. 3, at step (1), the MS uses the CDMA ranging code assigned to the urgent service type. Upon receiving the ranging code for urgent service type, at step (2), the BS allocates bandwidth for the MS to send the bandwidth request.

At step (3), the MS uses the allocated bandwidth from step (2) to send a bandwidth request for an urgent service data flow. Then, after receiving the bandwidth request, at step (4), the BS allocates bandwidth for the MS to send urgent service data. Finally, at step (5), the urgent service data flow is sent using the bandwidth allocated in step (4) with the transport CID (which can be allocated in step (4) or during network entry procedure) or the basic/primary/secondary CID for the MS.

Scheme 3

In Scheme 3, a service flow profile is predefined for each type of urgent service. A bandwidth request sent from the MS indicates the urgent service type.

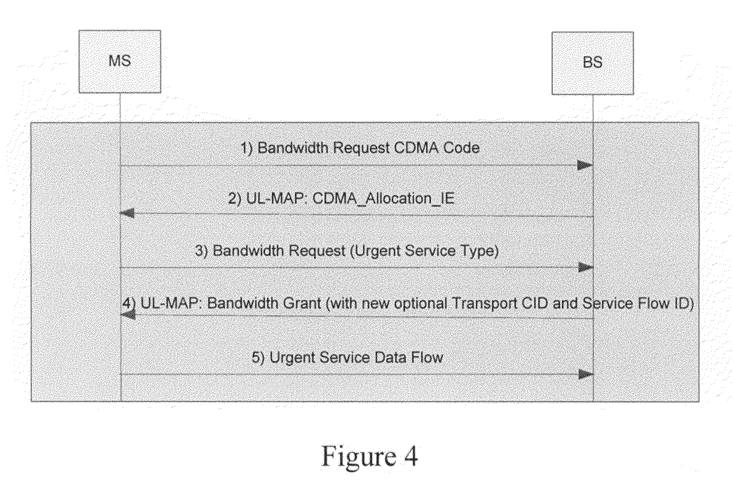

FIG. 4 illustrates the use of a bandwidth request indicating an urgent service type. Only the following steps as shown in FIG. 4 are taken when an urgent service is set up.

As shown in FIG. 4, at step (1), the MS uses a regular CDMA ranging code from bandwidth request ranging code set. Next, at step (2), upon receiving the ranging code, the BS allocates bandwidth for the MS to send a bandwidth request.

At step (3), the MS uses the allocated bandwidth from step (2) to send a bandwidth request for an urgent service data flow. The bandwidth request indicates the urgent service type. After receiving the bandwidth request for the urgent service, at step (4), the BS allocates bandwidth for the MS to send urgent service data. Finally, at step (5), the urgent service data flow is sent using the bandwidth allocated in step (4) with the transport CID (which can be allocated in step (4) or during a network entry procedure) or the basic/primary/secondary CID for the MS.

CID Allocated in Schemes 1, 2, and 3

In step (2) in Scheme 1 and in step (4) in schemes 2 and 3, the BS allocates bandwidth to the MS to carry urgent service data flow using UL MAP. This uplink allocation should include the resource information and also one of the following information if applicable:
the transport CID as well the service flow ID used to carry the urgent service data flow may be assigned either using UL-MAP or extended sub-header or MAC Management Message;
nothing, if transport CID and service flow CID are already assigned during network entry process such as ranging, registration. In this case, the BS can reserve and assign the CID and the service flow ID to the MS during network entry process if the service profile indicates that the MS supports the relative urgent services; or
nothing, if basic CID/primary CID/secondary CID is used to carry urgent service data flow.

As can be seen from the discussion above, one difference between schemes 2 and 3 is in the way that the MS notifies the BS about the setup of urgent service. In scheme 2, a CDMA code used while in scheme 3 a service type in the Bandwidth Request (BR) header.

Scheme 4

In scheme 4, one or more dedicated ranging code from the code subset for bandwidth request is reserved for urgent services. Different urgent service types can share the same ranging code if they have the same service flow requirement. All the MSs share the same ranging code for the same urgent service type. Upon receiving the dedicated ranging code for urgent service, the BS directly allocates bandwidth for MS to send DSA-REQ.

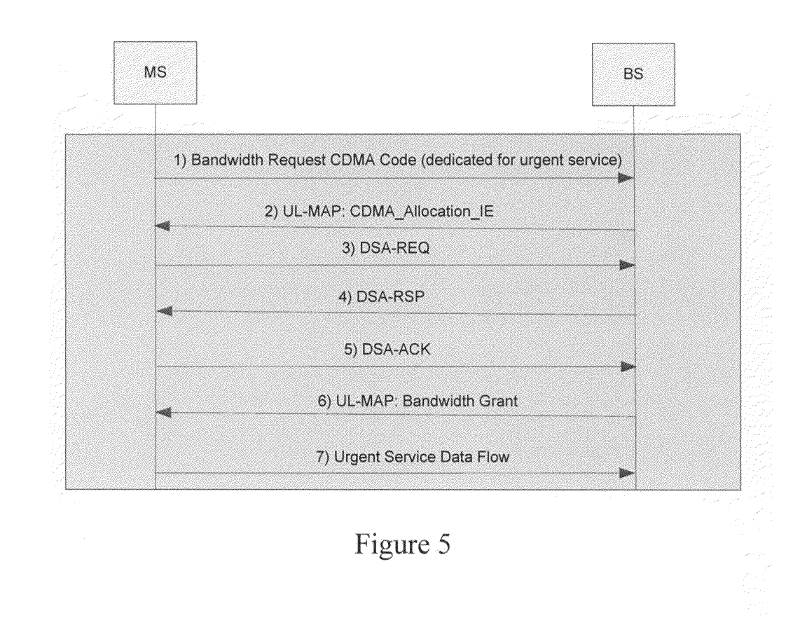

FIG. 5 illustrates the use of a dedicated bandwidth request ranging code for each urgent service. The steps as shown in FIG. 5 can be taken (without further steps) when an urgent service is set up.

As shown in FIG. 5, in a first step (1), the MS uses the CDMA ranging code assigned to the urgent service type. Upon receiving the ranging code for urgent service type, the BS allocates bandwidth for the MS to send a DSA-REQ. Next, in step (3), the MS uses the allocated bandwidth from step (2) to send a DSA-REQ for urgent service data flow. In response, in step (4), the BS assigns a transport CID and a service Flow ID in a DSA-RSP. Then, the MS acknowledges with a DSA-ACK in step (5).

In step (6), the BS allocates bandwidth for the MS to send urgent service data. Finally, in step (7), the urgent service data flow is sent using the bandwidth that was allocated in step (6) and using the transport CID that was allocated in step (4).

Scheme 5

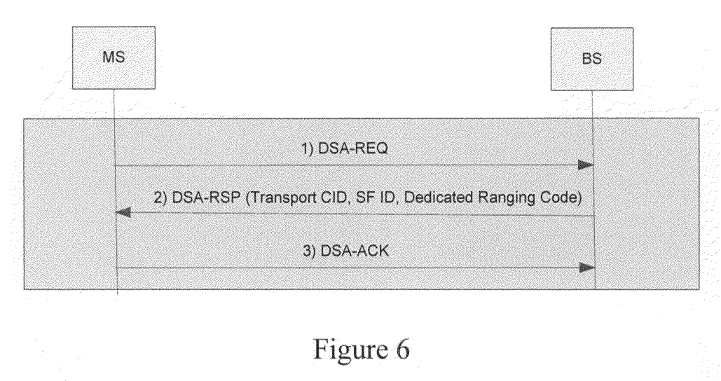

In Scheme 5, one or more dedicated ranging code from the code subset for bandwidth requests can be reserved for an MS for specific urgent services. Such dedicated ranging code can be assigned by the BS during the DSA procedure. FIG. 6 illustrates the assignment of a dedicated ranging code during a DSA procedure.

As shown in FIG. 6, in step (1), the MS can send a DSA-REQ to the BS. In response to the request, the BS in step (2), can send a DSA-RSP including a transport CID, a Service Flow (SF) ID, and a dedicated ranging code. Finally, the MS can acknowledge, in step (3), with a DSA-ACK. When the service flow is deleted then the dedicated ranging code can also be deallocated. The BS may reassign the dedicated ranging for some other purpose to any Mobile Station (MS).

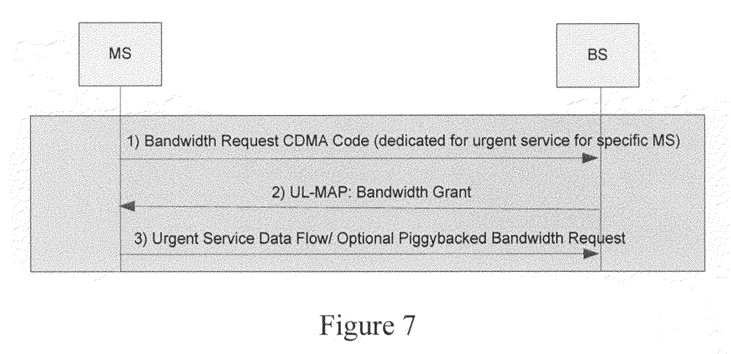

After such an assignment has been made during a DSA procedure, then, as shown in FIG. 7, during the urgent service session, after a silence period, the MS may need to set up the channel quickly to transmit the data. To accomplish such a purpose, the MS can (in step (1)) use the dedicated ranging code assigned in FIG. 6 to request for bandwidth. Upon receiving such Ranging Code, the BS allocates bandwidth to the MS right away without granting bandwidth for MS to send another bandwidth request and (in step (2)) sends the bandwidth grant to the MS in a UL-MAP message. The bandwidth allocated to the MS could be, for example, based on the minimum bit rate required for the service flow. If the MS has more data to send, the MS can, in step (3), send a piggybacked bandwidth request together with the data.

As can be seen from the discussion above, Scheme 1 can be viewed as a subset of Scheme 5.

Furthermore, combinations of the schemes can also be possible. As one example, one or more dedicated ranging codes from the code subset for bandwidth requests can be reserved for all the types of urgent services, and differentiation of the type of urgent service can be done based on an urgent service type field in the bandwidth request message. As another example, for push-to-talk service or gaming, Scheme 4 can be used for fast session/call setup and Scheme 5 can be used for fast channel setup during the session.

Though above schemes are defined for call setup for urgent service, these dedicated ranging codes for urgent services or a different set of ranging codes can be used by MS to request bandwidth for UL data for urgent service flows.

An implementation example of uplink bandwidth grant together with the transport CIOD and service flow ID is illustrated in the following table. The transport CID and service flow CID are included in an urgent service CID grant Information Element (IE). This newly defined IE is used to indicate to the MS that a new transport CID and service flow ID is assigned to the subsequent bandwidth allocation in the UL-MAP IE.

TABLE 1

| | Size | |
|---|---|---|
| Syntax | (bit) | Notes |
| Urgent-Service-CID-Grant_IE{ | | |
| Extended DIUC | 4 | |
| Length | 4 | |
| MS Basic CID | 16 | MS Basic CID |
| CID | 16 | Transport CID assigned |
| Service Flow CID | 32 | Service Flow CID assigned |
| } | | |

Using various embodiments of the present invention, the number of round trips (and corresponding delays due to propagation and signal processing) to set up a call can be reduced from 4 to 1 (using, for example, Scheme 1), 2 (using, for example, Schemes 2 or 3), or 3 (using Scheme 4), depending on the approach taken. Such a reduction can bring significant benefit, good user experience with urgent services, and can help to conform a system to the requirements of IEEE 802.16m.

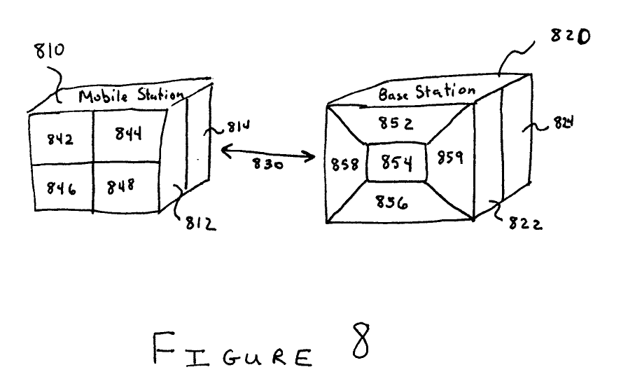

FIG. 8 illustrates a system according to an embodiment of the present invention. As illustrated, the system can include a mobile station 810 (including hardware 812 and software 814) and a base station 820 (including hardware 822 and software 824). The mobile station 810 and the base station 820 can connect to each other using a communication link 830, which may—for example—be a wireless communication link of a WiMAX network.

The mobile station 810 can include various units, such as a sending unit 842 configured to send a bandwidth request to the base station 820. The bandwidth request can include a code division multiple access code that is dedicated for an urgent service, the code division multiple access code can optionally be dedicated for the mobile station 810 in particular. The mobile station 810 can also include a processor 844 that prepares the bandwidth request and processes other messages to be sent or that are received.

The mobile station 810 can further include a receiving unit 846 configured to receive an uplink mapping message from the base station 820 in response to the bandwidth request, or in response to a second bandwidth request sent after the bandwidth request or in response to a dynamic service addition procedure (see, for example, FIGS. 2-5 and 7, for various way that the mobile station 810 and the base station 820 can interact). The uplink mapping message can include a bandwidth grant. The mobile station 810 can additionally include an initiation unit 848 configured to begin an urgent service data flow to the base station, in response to the uplink mapping message. A first message of the urgent service data flow can include a piggy-backed bandwidth request designed to modify the bandwidth granted by the base station 820.

The receiving unit 846 can optionally be configured to receive an assignment of the code division multiple access code in a dynamic service addition procedure prior to the sending unit 842 sending the bandwidth request.

The base station 820 can include a receiving unit 852 configured to receive the bandwidth request from a mobile station, as well as a sending unit 856 configured to send the uplink mapping message to the mobile station in response to the bandwidth request, or in response to a second bandwidth request sent after the bandwidth request or in response to a dynamic service addition procedure (see, for example, FIGS. 2-5 and 7, for various way that the mobile station 810 and the base station 820 can interact). The base station 820 can also include a processor 854 configured to process messages that are received or that are to be sent. The receiving unit 852 can further be configured to receive an urgent service data flow from the mobile station, in response to the uplink mapping message.

Optionally, the base station 820 can also include a first assigning unit 858 configured to assign the code division multiple access code in a dynamic service addition procedure prior to the receiving unit 852 receiving the bandwidth request. Also optionally, the base station 820 can include a second assigning unit 859 configured to assign a transport connection identifier and/or service flow identification in the uplink mapping message. The first assigning unit 858 is not required in order to include the second assigning unit 859—the labels “first” and “second” are just to distinguish the two assigning units from one another.

As noted above, the base station 820 and mobile station 810 can each include respective hardware (822, 812) and software (824, 814). In order to achieve the functionalities of the respective base station 820 and mobile station 810, each may be equipped with a computer program embodied on a computer readable medium (such as Digital Versatile Disc (DVD) or a flash memory) encoding instructions configured to perform various functions.

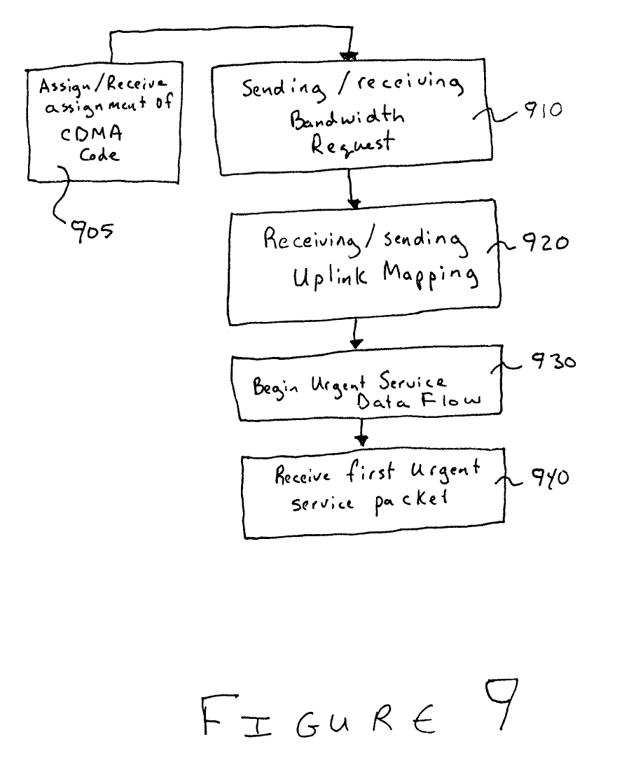

FIG. 9 illustrates a method according to an embodiment of the present invention. As illustrated in FIG. 9, the method can include sending a bandwidth request from a mobile station to a base station (and/or receiving a bandwidth request at a base station from a mobile station) 910. The bandwidth request can include a code division multiple access code that is dedicated for an urgent service, and which can optionally be specific to a particular mobile station. The code division multiple access code can be a bandwidth request code.

Next, the method can include receiving an uplink mapping message from the base station at the mobile station (and/or sending an uplink mapping message from the base station to the mobile station) 920 in response to the bandwidth request provided in 910, or in response to a second bandwidth request sent after the bandwidth request or in response to a dynamic service addition procedure (see, for example, FIGS. 2-5 and 7, for various way that the mobile station and the base station can interact). The uplink mapping message includes a bandwidth grant. The uplink mapping message can also include an assignment of a transport connection identifier and service flow identification.

Finally, the method can include beginning an urgent service data flow 930 to the base station (and receiving the first packet of the urgent service data flow at the base station 940), in response to the uplink mapping message. The first message of the urgent service data flow can include a piggy-backed bandwidth request, which may be useful in requesting expanded bandwidth. Alternatively, both the first message of the urgent service data flow and a subsequent message (including more than one subsequent message) can include a piggy-backed bandwidth request. Thus, there is no requirement that the piggy-backed bandwidth request appear only in the first message of the urgent service data flow.

Optionally, the method can include receiving an assignment of (or assigning) 905 the code division multiple access code in a dynamic service addition procedure prior to the sending/receiving the bandwidth request 910. The method can performed in a WiMAX network.

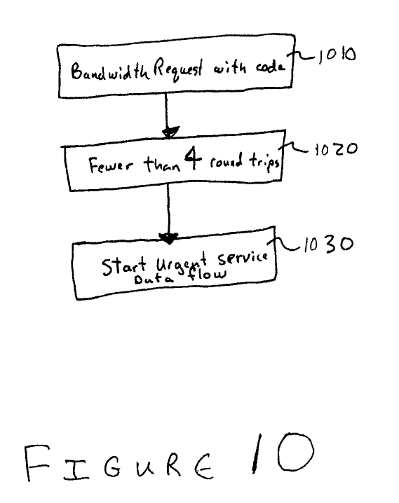

FIG. 10 illustrates a method according to an embodiment of the present invention. The method includes sending a bandwidth request 1010 with a code division multiple access code from a first network node to a second network node (and receiving the bandwidth request 1010 at the second network node). The method also includes beginning 1030 an urgent service data flow related to the bandwidth request after fewer than four round trips 1020 of communication between the first network node and the second network node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
sending a bandwidth request to a base station, wherein the bandwidth request comprises a code division multiple access code;
receiving an uplink mapping message from the base station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included; and
beginning an urgent service data flow to the base station, in response to the uplink mapping message.

2. The method of claim 1, wherein the code division multiple access code is dedicated either for an urgent service generally or for an urgent service for a particular mobile station.

3. The method of claim 1, wherein the uplink mapping message includes an assignment of a transport connection identifier and service flow identification.

4. The method of claim 1; wherein the code division multiple access code is a bandwidth request code.

5. The method of claim 1, wherein a first message or both the first message and a subsequent message of the urgent service data flow include a piggy-backed bandwidth request.

6. The method of claim 1, further comprising:
receiving an assignment of the code division multiple access code in a dynamic service addition procedure prior to the sending the bandwidth request.

7. A method, comprising:
receiving a bandwidth request from a mobile station, wherein the bandwidth request comprises a code division multiple access code;
sending an uplink mapping message to the mobile station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included; and
receiving an urgent service data flow from the mobile station, in response to the uplink mapping message.

8. The method of claim 7, wherein the code division multiple access code is dedicated either for an urgent service generally or for an urgent service for a particular mobile station.

9. The method of claim 7, further comprising:
assigning a transport connection identifier and service flow identification in the uplink mapping message.

10. The method of claim 7, wherein the code division multiple access code is a bandwidth request code.

11. The method of claim 7, wherein a first message or both the first message and a subsequent message of the urgent service data flow include a piggy-backed bandwidth request.

12. The method of claim 6, further comprising:
assigning the code division multiple access code in a dynamic service addition procedure prior to the receiving the bandwidth request.

13. An apparatus, comprising:
sending means for sending a bandwidth request to a base station, wherein the bandwidth request comprises a code division multiple access code;
receiving means for receiving an uplink mapping message from the base station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included; and
initiation means for beginning an urgent service data flow to the base station, in response to the uplink mapping message.

14. The apparatus of claim 13, wherein the code division multiple access code is dedicated either for the urgent service for a particular mobile station.

15. The apparatus of claim 13, wherein the uplink mapping message includes an assignment of a transport connection identifier and service flow identification.

16. The apparatus of claim 13, wherein the code division multiple access code is a bandwidth request code.

17. The apparatus of claim 12, wherein a first message or the first message and a subsequent message both of the urgent service data flow include a piggy-backed bandwidth request.

18. The apparatus of claim 13, further comprising:
second receiving means for receiving an assignment of the code division multiple access code in a dynamic service addition procedure prior to the sending the bandwidth request.

19. An apparatus, comprising:
first receiving means for receiving a bandwidth request from a mobile station, wherein the bandwidth request comprises a code division multiple access code;
sending means for sending an uplink mapping message to the mobile station in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included; and
second receiving means for receiving an urgent service data flow from the mobile station, in response to the uplink mapping message.

20. The apparatus of claim 19, wherein the code division multiple access code is dedicated either for an urgent service generally or for an urgent service for a particular mobile station.

21. The apparatus of claim 19, further comprising:
assigning means for assigning a transport connection identifier and service flow identification in the uplink mapping message.

22. The apparatus of claim 19, wherein the code division multiple access code is a bandwidth request code.

23. The apparatus of claim 19, wherein a first message or the first message and a subsequent message both of the urgent service data flow include a piggy-backed bandwidth request.

24. The apparatus of claim 19, further comprising:
assigning means for assigning the code division multiple access code in a dynamic service addition procedure prior to the receiving the bandwidth request.

25. A system, comprising:
first sending means for sending a bandwidth request, wherein the bandwidth request comprises a code division multiple access code;
first receiving means for receiving the bandwidth request;
processing means for processing the request;
second sending means for sending an uplink mapping message in response to the bandwidth request or in response to a second bandwidth request sent after the bandwidth request or in response to a dynamic service addition procedure, wherein the uplink mapping message includes a bandwidth grant, and wherein at most one, and at fewest neither, of the second bandwidth request or the dynamic service addition procedure is included;
receiving means for receiving the uplink mapping message; and
initiation means for beginning an urgent service data flow, in response to the uplink mapping message.
